(19) United States
(12) Patent Application Publication
(10) Pub. No.: US 2015/0066588 A1
(43) Pub. Date: Mar. 5, 2015

(54) METHOD FOR REDESIGNING ONE OR MORE PRODUCT OR PROCESS PARAMETERS OF A MANUFACTURED ARTICLE

(71) Applicant: The Procter & Gamble Company, Cincinnati, OH (US)

(72) Inventor: Helen Louise Von Den Steinen, Bad Soden Am Taunus (DE)

(21) Appl. No.: 14/475,938

(22) Filed: Sep. 3, 2014

(30) Foreign Application Priority Data
Sep. 3, 2013 (EP) 13182727.1
Jul. 23, 2014 (EP) 14178116.1

(51) Int. Cl. G06Q 10/10; G06Q 30/02

(52) U.S. Cl. CPC G06Q 10/101; G06Q 30/0201; G06Q 30/0282
USPC 705/7.29

(57) ABSTRACT

Method for redesigning one or more product or process parameters of a first manufactured article, to provide different product or process parameters of a second, transformed, manufactured article, comprising: (a) associating a unique identifier with individual first manufactured articles, or with groups thereof; (b) capturing and recording product data and/or process data relating to the first manufactured articles; (c) soliciting and recording consumer feedback relating: to in-use performance of the first manufactured articles; (d) correlating consumer feedback with product data and/or process data of a specific, individual, first manufactured article by means of the unique identifier; (e) determining different product or process parameters for a second manufactured article; and (f) applying one or more different product or process parameters to the first manufactured articles to transform them into second manufactured articles, the second manufactured articles being better adapted to meet consumer needs than the first manufactured article.

### FIELD OF THE INVENTION

The present invention relates to a method for redesigning one or more product or process parameters of a first manufactured article, in order to provide different product or process parameters of a second, transformed, manufactured article.

### BACKGROUND OF THE INVENTION

Manufacturers strive to provide a consistent product quality to the end-users of the product In most cases quality assurance is provided by means of process and product standards and specifications which are set by the manufacturer. Various parameters may be assigned target values, as well as upper and lower limits. If a product does not meet the required specifications, that is to say if one or more parameters tracks outside of the upper or lower limits, then the product is not released for shipment, but instead the product may be reworked, recycled or scrapped. Typically quality assurance measurements are made on an intermediate or finished product taken from the production line, and often taken to a quality assurance laboratory for the measurements to be made.

Extensive consumer research may be undertaken during the development stage of a new product in order to establish which parameters are most relevant and important to the consumer, and quality target values, and upper and lower limits, may be determined accordingly. Setting a breadth of specification between upper and lower limits which is too wide is undesirable because at least some consumers may be dissatisfied with the quality of the product. Conversely, setting a breadth of specification between upper and lower limits which is too narrow is undesirable because it increases manufacturing costs, and increases rework, recycle and scrap rates.

US 20070203604, published on Aug. 30, 2007, discloses a product quality tracking system comprising a database for storing identification codes and reference numerals of a plurality of products, and for storing quality messages; a reading device; a recording module; and a statistic module for analyzing quality messages of a plurality of products having identical identification codes.

It would be desirable to provide a method that would enable consumer feedback to generate quality information Which is used for refining process and product standards and specifications.

### SUMMARY OF THE INVENTION

The present invention relates to a method for redesigning one or more product or process parameters of a first manufactured article, in order to provide different product or process parameters of a second, transformed, manufactured article, wherein the method comprises the steps of:

i) associating a unique identifier with individual first manufactured articles, or with groups of first manufactured articles;

ii) capturing and recording product data and/or process data relating to the first manufactured articles;

iii) soliciting and recording consumer feedback relating to in use performance of the first manufactured articles;

iv) correlating consumer feedback with product data and/or process data of a specific, individual, first manufactured article by means of the unique identifier;

v) determining different product or process parameters for a second manufactured article; and

vi) applying one or more different product or process parameters to the first manufactured articles to transform them into second manufactured articles, the second manufactured articles being better adapted to meet consumer needs than the first manufactured article.

### DETAILED DESCRIPTION OF THE INVENTION

### Definitions

“Consumer feedback” means any kind of information provided by the consumer as end-user which is or may be relevant to product quality data. Consumer feedback includes, for example, responses to questionnaires or interviews, complaints made by dissatisfied customers, any of which may be may be recorded in written form, or as audio or video recording; and/or images of product in use or after use. Preferably, consumer feedback is transmitted from the consumer back to the manufacturer by written communication, by verbal communication, by electronic communication, by internet interface, or combinations thereof, preferably by means of telephone; mobile devices such as mobile telephones, smartphones, tablets.

In general, a product is designed to meet certain demands and expectations of the end-user. The fulfillment, or the lack of fulfillment, of these demands and expectations is referred to herein as the “in use performance”. In use performance may be measured, quantitatively and/or qualitatively, by means of data collected during use of the product. In use performance data may be collected, via sensors, or by recordings made by the consumer, diaries etc.

“Product data” means data collected during the manufacture of the product. Product data may be or product quality data, preferably measurements, images, raw material data, or combinations thereof. Product data may be recorded automatically in the manufacturing process, or may be generated off-line, for example in a quality assurance laboratory.

“Process data” means data collected from the manufacturing process. Process data may be process performance data, preferably measurements, images, or combinations thereof. Process data are typically measured, using sensors in the manufacturing process for example, and recorded automatically.

“Quality control data”/“quality data standards” means manufacturing standards, parameter targets, upper and lower limits, “out of spec.” limits, etc.

“Unique identifier” means, for example, serial number, bar code, QR code, etc. Preferably a unique identifier is applied to each individual product. However a unique identifier may also be applied to a bundle of individual products, or to a package containing multiple individual products. In addition, the unique identifier may be used, for purposes which may or may not be linked directly with the consumer and product quality data, e.g. consumer loyalty programmes, anti-counterfeit systems, track and trace systems.

According to the present invention, quality information is generated by correlating product data and/or process data and consumer feedback, by means of the unique identifier. The unique identifier is used to associate specific, individual manufactured articles and the product data and/or process data generated from the manufacture of those articles with consumer feedback. Useful quality information can be generated from the correlation.

The quality information generated from the correlation may be evaluated with the aid of algorithms, spreadsheets, graphical interpretation, etc. Preferably, the quality information is applied to improve quality control data, quality data standards, process control strategies, process and product causal relationships, prognostics, product or process design improvements, product or process models, or combinations thereof.

In a preferred embodiment of the present invention, the manufactured articles are composite products produced by a process of web converting and sequential addition of component parts. Particularly preferred, composite products of this type are absorbent articles. The term absorbent articles is used herein to refer to devices that absorb and contain body exudates, and, more specifically, to refer to devices that are placed against or in proximity to the body of the wearer to absorb and contain the various exudates discharged from the body. Absorbent articles may include diapers, training pants, adult incontinence undergarments, feminine hygiene products, and the like. In the following example the invention will be described with reference to absorbent articles.

The present disclosure relates to methods and systems for providing quality information for use in the production of manufactured articles, for example absorbent articles. More particularly, the methods and systems herein may be configured with a controller to correlate manufacturing parameters and consumer feedback parameters with individual manufactured articles manufactured by a converting apparatus. The controller may adjust target manufacturing parameters on the converting apparatus based on the consumer feedback parameters and optionally on correlated manufacturing parameters. Embodiments of the systems herein may include a converting line adapted to produce manufactured articles, such as absorbent articles, wherein the converting line includes inspection sensors, process sensors, and a controller connected with a communication network. Inspection sensors may be configured to inspect substrates and/or component parts advancing along the converting line and communicate inspection parameters to the controller. Process sensors may be configured to monitor equipment on the converting line and communicate process parameters to the controller.

The systems herein are adapted to receive performance feedback parameters provided by consumers of the manufactured articles. The systems may further correlate inspection parameters, process parameters, and performance feedback parameters with individual manufactured articles produced on the converting line.

As discussed above, the controller may also be adapted to receive performance feedback parameters. Performance feedback parameters may be generated in various ways, as described above, and includes various information and/or data relating to the articles produced by the converting line. For example, performance parameters as set out herein are generated by consumer feedback, and may be further supplemented by other data, for example data generated as a result of laboratory testing. Performance parameters are collected as a result of soliciting and recording consumer feedback relating to in use performance of the manufactured articles. Examples of performance parameters in the field of absorbent articles may include data relating to the separation of back ears from diapers while under tension; leakage; component alignment;

and absorbent article fit. It is to be appreciated that consumer feedback may include any kind of information provided by the consumer as end-user which is or may be relevant to product quality data. Consumer feedback includes, for example, responses to questionnaires or interviews, complaints made by dissatisfied customers, any of which may be may be recorded in written form, or as audio or video recording; and/or images of product in use or after use. Performance parameters may be transmitted directly from feedback providers to the controller in various ways, such as via written communication; electronic communication; internet interface; and/or combinations thereof. As such, performance parameters can be communicated with various types of devices, such as telephones; computers; mobile devices such as mobile telephones; smart phones; tablets; and the like. Performance parameters may also be transmitted in various ways feedback providers to intermediaries, which can then communicate and/or enter the performance parameters into the controller.

### EXAMPLE

Diapers are absorbent articles which typically comprise topsheet, backsheet, and an absorbent core placed between the topsheet and the back sheet to form the body of the diaper. A diaper may farther comprise front and/or back ears which are attached to the body of the diapers in the waist region. In some embodiments the ears have areas which engage, either adhesively or otherwise, with a landing zone located elsewhere on the diaper, typically also located in the waist region. The purpose of the ears is to secure the diaper around the waist of the wearer. The adhesive area may optionally be protected by release tab which is peeled away when the ear is to be applied to the landing zone. In use, the child-carer positions the diaper around the body of the wearer, pulls the ear into position, releasing the release layer if present, and applies the ear to the landing zone to fit the diaper to the child or baby. In some cases the diaper, in particular the ear, may be damaged or torn during this process. Such a failure would be considered as a quality incident.

According to the present Invention, consumer feedback would be solicited from the consumer, in this case the child-carer, by means of a report of the failure, ear torn or damaged, submitted back to the manufacturer in combination with the unique identifier associated with the diaper in question.

In order to maximize the data obtained, the child-carer may be asked to report the nature and extent of the failure, for example by comparing the diaper against a series of images which depict failure of the ear in different positions, and to different extent, and whereby the child-carer identifies the image which most closely depicts the failure experienced. Such a series of images could be presented in a questionnaire, but preferably could be presented by means of a web-based interface on a computer, tablet or other mobile device.

According to the present invention, the manufacturer correlates product data and/or process data which has been captured and recorded during manufacture and consumer feedback. This can be achieved by using the unique identifier associated with the specific, individual diaper. By repeating this process across multiple (e.g. dozens, hundreds, etc.) of reports of consumer feedback, the manufacturer can identify the most critical product and process quality attributes which contribute to quality incidents experienced by the end user.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for redesigning one or more product or process parameters of a first manufactured article, in order to provide different product or process parameters of a second, transformed, manufactured article, wherein the method comprises the steps of:
i) associating a unique identifier with individual first manufactured articles, or with groups of first manufactured articles;
ii) capturing and recording product data or process data relating to the first manufactured articles;
iii) soliciting and recording consumer feedback relating to in use performance of the first manufactured articles;
iv) correlating consumer feedback with product data or process data of a specific, individual, first manufactured article by means of the unique identifier,
v) determining different product or process parameters for a second manufactured article; and
vi) applying one or more different product or process parameters to the first manufactured articles to transform them into second manufactured articles, the second manufactured articles being better adapted to meet consumer needs than the first manufactured article.

2. The method of claim 1 wherein the unique identifier is selected from the group consisting of serial numbers, bar codes, QR codes, or combinations thereof.

3. The method of claim 1 wherein the product data and process data are selected from the group consisting of process performance data or product quality data.

4. The method of claim 3 wherein the product data and process data is selected from the group consisting of measurements, images, raw material data, or combinations thereof.

5. The method of claim 1 wherein the in use performance data are recorded by means selected from the group consisting of questionnaire, sensor, image capture, audio recording, video recording or combinations thereof.

6. The method of claim 5 wherein the in use performance data are transmitted by means of written communication, by electronic communication, by verbal communication or by internet interface, or combinations thereof.

7. The method of claim 6 wherein the in use performance data is transmitted by means of telephone; or mobile devices, such as mobile telephones, smartphones, tablets.

8. The method of claim 1 wherein the quality information generated by correlating the production data to the consumer feedback is selected from the group consisting of quality control data, quality data standards, process control strategies, process and product causal relationships, prognostics, product or process design improvements, product or process models, or combinations thereof.

9. The method of claim 1 wherein the manufactured articles are composite products produced by a process of web converting and sequential addition of component parts.

10. A product quality tracking system for use in the production of manufactured articles, the system comprising:
i) a database comprising a field for storing identifiers, a field for storing production data, and a consumer feedback field;
ii) a first recording module capable of recording production data relating to the manufactured articles;
iii) a second recording module capable of recording consumer feedback relating to in use performance of the manufactured articles;
iv) a module for correlating production data and consumer feedback, by means of the unique identifier, to specific, individual manufactured articles and thereby generating quality information from the correlation.

11. The product quality tracking system of claim 10 wherein the unique identifier is selected from the group consisting of serial numbers, bar codes, QR codes, or combinations thereof.

12. The product quality tracking system of claim 10 wherein the production data are selected from the group consisting of process performance data or product quality data.

13. The product quality tracking system of claim 12 wherein the production data are selected. from the group consisting of measurements, images, raw material data, or combinations thereof.

14. The product quality tracking system of claim 10 wherein the in use performance data is recorded by means selected from the group consisting of questionnaire, sensor, image capture, audio recording, video recording or combinations thereof.

15. The product quality tracking system of claim 14 wherein the in use performance data is transmitted to the second recording module by means of written communication, by electronic communication, by verbal communication, by internet interface, or combinations thereof.

16. The product quality tracking system of claim 15 wherein the in use performance data are transmitted to the second recording module means of telephone; or mobile devices, such as mobile telephones, smartphones, tablets.

17. The product quality tracking system of claim 10 wherein the quality information generated by correlating the production data to the consumer feedback is selected from the group consisting of quality control data, quality data standards, process control strategies, process and product causal relationships, prognostics, product or process design improvements, product or process models, or combinations thereof.

18. The product quality tracking system of claim 10 wherein the manufactured articles are composite products produced by a process of web converting and sequential addition of component parts.
